(19) United States
(12) Patent Application Publication
(10) Pub. No.: US 2017/0001807 A1
(43) Pub. Date: Jan. 5, 2017

(54) Equipment Isolation System

(71) Applicant: Remsafe Pty Ltd., Balcatta (AU)

(72) Inventors: Michael Charles Lane, Dianella (AU); Kazimierz Kacperek, Ocean Reef (AU); Jack Mross, Fremantle (AU)

(21) Appl. No.: 15/197,488

(22) Filed: Jun. 29, 2016

(30) Foreign Application Priority Data
Jun. 30, 2015 (AU) 2015902556

(51) Int. Cl. B65G 43/00; G05B 19/406

(52) U.S. Cl. CPC B65G 43/00; G05B 19/406; G05B 2219/33204

(57) ABSTRACT

An equipment isolation system (10) comprising at least one equipment item (20,21,25) energisable by an energy source (30) and a control system (50,260) for automatically isolating said at least one equipment item (20,21,25) from said energy source (30) to an isolated state, wherein said equipment isolation system (10) includes means for securing the integrity of operation of said equipment isolation system, said securing means (21A,25A,50,S,900) including at least one monitoring means (50,S,900) for continuously monitoring the isolation state of said at least one equipment item (20,21,25) through detection of undesired energy flow or possible energy flow therein.

This invention relates to an equipment isolation system. More specifically, the invention relates to an equipment isolation system where stored energy is dissipated prior to the equipment being isolated.

Various types of equipment must be isolated from a range of energy sources including electrical energy (the most common) and mechanical energy (including pressure and potential energy) to enable safe maintenance and other work to be carried out. Conveyor belt systems used in the mining industry for transporting iron ore or other bulk materials which can span significant distances are one such example of equipment which may require to be isolated from time to time.

The distances such conveyor belt systems span can be in the range of many kilometres. Such conveyors are typically powered by electric drive motors: three phase electrical power is supplied wherein the voltage may range from low voltage ranges (from below 600V to 1000V AC), to medium and high voltage ranges (in the multiple kV range and extending to above 10 kV AC and even 33 kV AC). Such conveyors typically include corresponding brake systems which are also electrically operated.

Although different mine procedures and relevant safety standards may apply, a typical pre-requisite before permitting mechanical maintenance or other activity involving access to the conveyor belt system involves the electrical isolation of the conveyor belt system. This isolation ensures that the energy source powering the conveyor belts and associated equipment, i.e. electrical power, is removed from systems or components that—if energised—could cause a safety hazard. It will however be understood that equipment items other than conveyor belt systems and other mining industry equipment also require isolation for maintenance and other purposes.

The isolation process is invariably safety critical and has, in the past, been time consuming, as described for example in the introduction to the Applicant's granted Australian Patent No. 2010310881 and International Publication No. WO 2012/142674, the contents of which are hereby incorporated herein by reference.

The remote isolation system described in Australian Patent No. 2010310881 enables equipment isolation to be requested at a remote isolation station associated with the equipment and subsequently approved through a plant control system, without mandatory visitation to the equipment by authorised isolation personnel.

This remote isolation system significantly reduces the time required to achieve safe isolation, and more specifically the production downtime that would normally be involved with such an isolation, which can be very costly.

Whilst the Applicant's remote isolation system is very efficient and attractive to mining companies seeking to minimise the downtime of their plant critical equipment, certain applications may warrant further safety assurances being provided in respect of any isolations to be effected. This is partly due to the fact that, for a range of reasons, equipment may revert or be switched from an isolated state to an energised state when such a change in state is not desired and which in turn may result in one or more safety hazards. For example, equipment may accidentally be re-energised even though work on that equipment is intended or currently taking place. Damage to components of, or failure of certain elements of, the remote isolation system can also be caused by a range of human and environmental factors. Such damage or failure could adversely affect operation of the remote isolation system. In certain circumstances, it may also be desirable to identify potential threats to the integrity of the remote isolation system before damage or other hazards result.

It is therefore an object of the present invention to mitigate against threats that could interfere with the integrity of the isolation system as described in Australian Patent No. 2010310881, International Publication No. WO 2012/142674 and other isolation systems.

With this object in view, the present invention provides an equipment isolation system comprising:

at least one equipment item energisable by an energy source; and

a control system for automatically isolating said at least one equipment item from said energy source to an isolated state,

wherein said equipment isolation system includes means for securing the integrity of operation of said equipment isolation system, said securing means including at least one monitoring means for continuously monitoring the isolation state of said at least one equipment item through detection of undesired energy flow or possible energy flow therein. Such energy flows have a nature that present safety hazards to operators and the potential for damage to equipment.

The system is particularly intended to continuously secure the integrity of the isolated state of the at least one equipment item when isolated. Threats to integrity of equipment isolation typically imply safety hazards that may be pre-empted and compensated for by the equipment isolation system. As a plurality of potential threats to safe operation of the equipment isolation system may exist, the securing means involves the use of a plurality of monitoring systems or means, typically including a range of sensors as described below, addressing at least the most probable, and so substantial, threats to the isolation system. Typically, this will involve monitoring of control system operation as well as monitoring of the isolated equipment. Such continual monitoring will typically involve continually polling of all sensors arranged for operation on the equipment item or items to ensure that no energy is detected during an isolation event. Typically, if any errors are detected during such continual polling, warnings are immediately effected.

Preferably, such monitoring will be effected prior to an isolation being effected and as part of the process to ensure that all energy which could potentially cause a safety hazard is dissipated from the equipment item before isolation is complete.

Preferably, and additionally, such monitoring will also be effected during an isolation to ensure the integrity of the isolation is not compromised once it has been instigated.

Monitoring is advantageously conducted substantially continuously so that any hazard resulting or likely to result from the integrity of the equipment isolation system being compromised is detected as soon as possible and mitigated to the extent possible. Advantageously, monitoring should be conducted to address any substantial threat to equipment isolation system integrity. A hazard analysis should be conducted to identify substantial threats bearing in mind the required safety rating, for example SIL rating, for the equipment isolation system. Such threats would include safety critical faults in the equipment isolation system.

Preferably, each monitoring means operates independently of another and may be of different nature, for example, including sensors of different nature to indicate energy flows or the possibility of energy flows in the equipment item. This feature enables cross-checking of isolation integrity and enhances safety.

The securing means may advantageously form part of the control system. The securing means could include one or more electronic, mechanical or electro-mechanical device(s) for monitoring important components of the equipment isolation system, each forming part of the control system. Securing means are conveniently selected for their ease of monitoring. Buttons and switches, for example, are typically easily monitored since an ON or OFF state is readily identified. A plurality of securing means—typically of different structure and having different modes of operation—provides most assurance in monitoring of isolation integrity.

As alluded to hereinbefore, such monitoring by the securing means may occur both prior to and/or during intended isolation of the equipment item as specific cases may require. The monitoring device(s) would typically provide a signal to the control system including a signal representative of a hazard to the integrity of the equipment isolation system. Sensors may be used to monitor the equipment isolation system providing signals indicating tampering, failure of, or other threats to, the integrity of the equipment isolation system. An alert signal may be issued by the control system for warning personnel of resulting or possible hazards and of any corrective action which may be initiated.

The securing means may also form part of the equipment item and be operated as part of the isolation process. In certain applications, the securing means may be a device detecting and/or preventing any risk of uncontrolled energy release from the equipment item. For example, a mechanical device such as an automated clamping means or locking means may desirably be used to prevent conveyor belt movement or slipping in the case of a conveyor belt system. In another arrangement, locking means, such as pins, may also desirably be used to prevent movement of specific components within a shuttle conveyor system during isolation. Such securing means may be integrated with the equipment isolation system which authorises and implements automated operation of the mechanical device using suitable drives to reduce manual effort and increase safety and speed of operation.

The securing means may include a sensor, or preferably a plurality of sensors, for detecting and/or monitoring undesired energy flow in the equipment item. To that end, sensors are advantageously monitored for expected output signals indicative of an isolated state of equipment item(s). Such signals could, for example, include a signal pulse of desired nature, switch or button position indication and/or a signal profile of expected nature for the equipment in isolated state (e.g. via monitoring of one or more voltage monitor(s) or relay(s)). Examples of sensors or monitors of this type are movement sensors, speed sensors, proximity sensors, voltage sensors, current sensors, temperature sensors, flow sensors and pressure sensors—it being understood that the equipment isolation system is suitable for isolating equipment from various energy sources whether electrical, thermal or mechanical in nature and combinations of energy sources including electrical energy, kinetic energy and potential energy.

Continuous monitoring of integrity of operation of the equipment isolation system may include more than one sensor type with sensors being advantageously used to continuously monitor operation of the control system and its components, for example, as described below in respect of the Applicant's remote isolation systems, and the isolated equipment itself. Such monitoring of isolation integrity may typically relate to the dissipation or disconnection of electrical energy, but is not so limited. For example, such monitoring of isolation integrity could—again without limitation—be effected for equipment that requires the release of pressure from a pressurised system; the draining of fluid from one or more reservoirs or tanks; or the suitable containment of a substance or chemical before a next process step can be permitted. It will therefore be understood that the isolation system can be used effectively for a wide variety of equipment and, indeed, that different forms of monitoring of isolation integrity could be utilised across a single plant comprising a plurality of equipment items, for example an industrial or mining plant comprising complex equipment arrangements.

The equipment isolation system may implement steps to dissipate energy from an isolated, or to be isolated, equipment item including monitoring of energy stored within the equipment item through stored energy tests. Conveyor belt systems including braking systems with brake(s) for slowing and stopping conveyor belt movement are just one example of an equipment item which may be monitored or checked for energy stored before being isolated. In such a case, the control system may for example command release of the conveyor brakes after which the conveyor belt may be continuously monitored for movement. When the conveyor belt is confirmed stationary, the brakes may be re-applied. The brakes may then be released again with the conveyor belt again being continuously monitored for movement, hence providing an indication of any hazardous stored energy that may exist. This braking cycle procedure (in which brakes are released, applied, released and re-applied) may be repeated for as long, or as many times, as necessary until the control system confirms, through monitoring of conveyor belt movement and/or brake state, that the conveyor belt is completely stationary with all stored energy (typically potential energy) released or dissipated. Belt speed sensors, belt slack monitors and/or belt standstill monitors may also conveniently be used for conveyor belt movement monitoring.

At least one, and preferably a plurality, of the required sensors for continuous monitoring of isolation integrity in conveyor belt systems should be selected from the group consisting of belt speed sensors, belt standstill monitors, belt slack monitors, belt clamp position sensors, braking system temperature sensors and braking system pressure sensors, including brake fluid pressure sensors and brake fluid temperature sensors. For example, conveyor brake fluid pressure may be monitored to ensure that pressure is at a required set-point when the brakes are engaged and a corresponding conveyor belt is isolated.

It is to be understood that stored energy tests, conducted prior to and/or during isolation, are not limited only to motion or position detection for equipment items. The nature of the energy test to be applied depends on the nature of the equipment and the nature of the energy that may be stored therein. Other parameters such as temperature and pressure may be relevant for other equipment items and even conveyor belt systems. For example, conveyor brake fluid pressure may be monitored to ensure that pressure is at a required set-point when the brakes are engaged and a corresponding conveyor belt is isolated.

Securing of isolation system operation integrity is not intended to interfere with purposeful continuation of energy supply to selected equipment items where authorised by the control system. For example, in the case of conveyor belt systems, even when the conveyor itself is isolated, it may be necessary—as alluded to above—to maintain an energy supply to the conveyor braking system to ensure that braking action is applied as required during an isolation or energy dissipation process. Other components for other equipment could similarly remain energised in this way depending on specific equipment types and prevailing conditions.

Where equipment to be isolated is under the control of, or otherwise in communication with, an existing control system such as a Distributed Control System (DCS), Programmable Logic Controller (PLC) and Supervisory Control and Data Acquisition System (SCADA), the equipment isolation system is provided with a control and diagnostic system such that the status and any relevant alarms are visible from control panel(s) for the equipment or plant including the equipment.

The equipment isolation system may advantageously be operated in accordance with the Applicant's remote isolation systems which approve isolation on permissible request logged by an operator at a remote isolation station. Such systems and components are described, for example, in Australian Patent No. 2010310881 and the Applicants Australian Provisional Patent Application Nos. 2015902554, 2015902557, 2015902558, 2015902559, 2015902560, 2015902561, 2015902562, 2015902564, 2015902565 and 2015902566, each filed on 30 Jun. 2015, the contents of which are incorporated herein by way of reference.

Such an equipment isolation system advantageously includes, as described in the Applicants Australian Provisional Patent Application No. 2015902554, an isolation switch movable between a first position in which an equipment item is energised by an energy source and a second isolated position in which the equipment item is isolated from the energy source. A locking device co-operates with the switch for locking it into said isolated position in a lockout process. The position of the locking device, or a component lock member, is preferably monitored by sensors and the control system for correct positioning whether for isolated and de-isolated states when using the equipment isolation system of the present invention. An alert signal may issue where there is any variation from such correct positioning. For example, tampering with a locked out equipment isolation switch may also be monitored by sensors, such as proximity sensors, provided specifically for such a purpose.

A remote isolation station for use, for example in the Applicant's remote isolation systems, includes a control panel to implement and monitor isolation procedures using the Applicants remote isolation system. The control panel is protected by an enclosure with a lockable door enabling access to important components of the isolation system. The enclosure is therefore advantageously provided with perimeter security monitoring means that detect unauthorised attempts to access or tamper with the enclosure by force. Such attempts would include environmental factors such as climatic factors. A further level of security is preferably also provided for internal components of the remote isolation system such as the equipment isolation switch as described above.

The equipment isolation system as above described may usefully be applied to a range of equipment and processes. For example, and without intending limitation to the mining or quarrying industry, such equipment may include various types of conveyors (e.g. screw conveyors, vibrating conveyors etc), bucket elevators, screeners, crushers, feeders (e.g. vibro-feeders, feed-gates etc) for use in material handling processes, as well as equipment items such as fans, blowers and pumps, including liquid and fluid pumps of different types.

The term “isolation” as used in this specification is to be understood in its maintenance engineering and legal sense as not simply turning off a supply of energy to equipment, whatever the nature of that energy, but removing and/or dissipating energy to provide a safe work environment as required by applicable occupational health and safety regulations. In the case of electricity, as just one example, isolation is not achieved simply by turning off a power supply to the equipment. In such cases, the equipment could accidentally re-start or be restarted and cause injury to personnel, or worse. Isolation instead prevents such accidental re-starting and typically will also involve processes to dissipate any hazardous stored energy, in whatever form that energy may take (e.g. potential energy), from the equipment. For example, such an additional energy dissipation step could be effected in respect of a conveyor belt system by way of the braking cycle procedure as described in the Applicant's Australian Provisional Patent Application No. 2015902565, the contents of which are incorporated herein by way of reference.

The equipment isolation system may be more fully understood from the following description of preferred embodiments thereof made with reference to the following drawings in which:

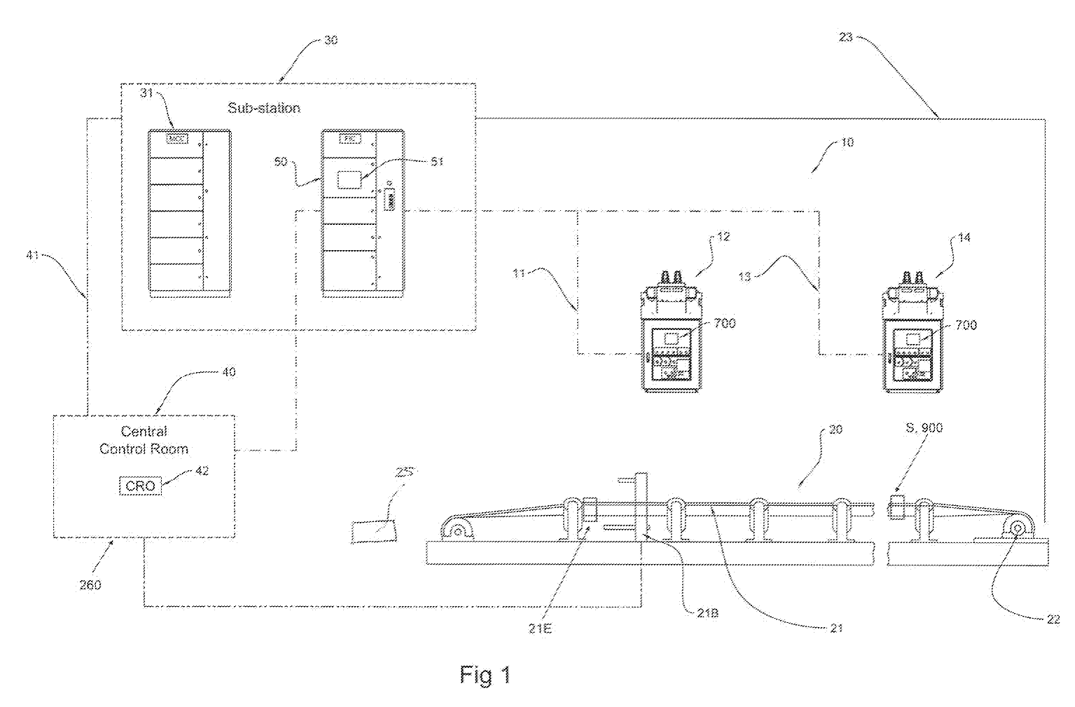

FIG. 1 shows a schematic layout of an equipment isolation system as applied to a conveyor belt system for which isolation integrity is monitored in accordance with preferred embodiments of the present invention.

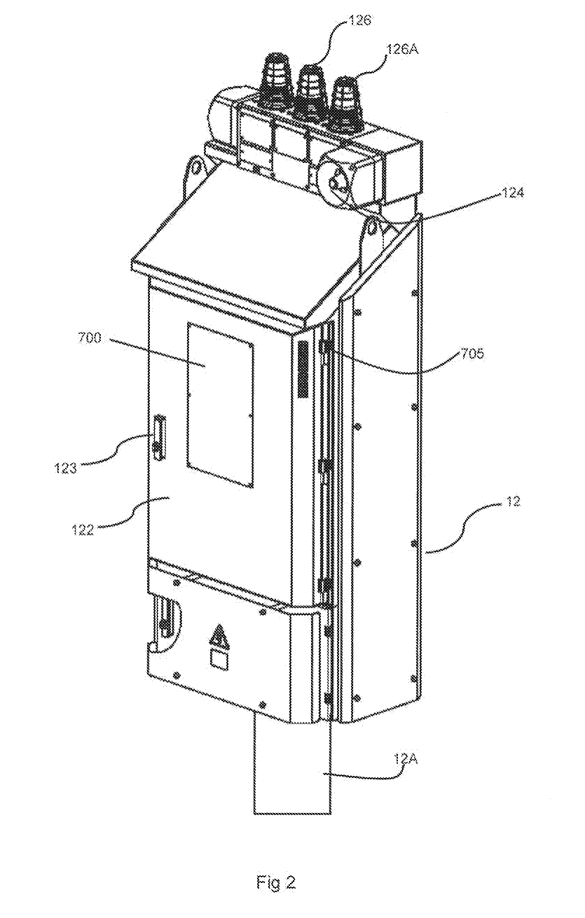

FIG. 2 shows a schematic diagram of the exterior of a remote isolation station configured to implement the equipment isolation system of FIG. 1.

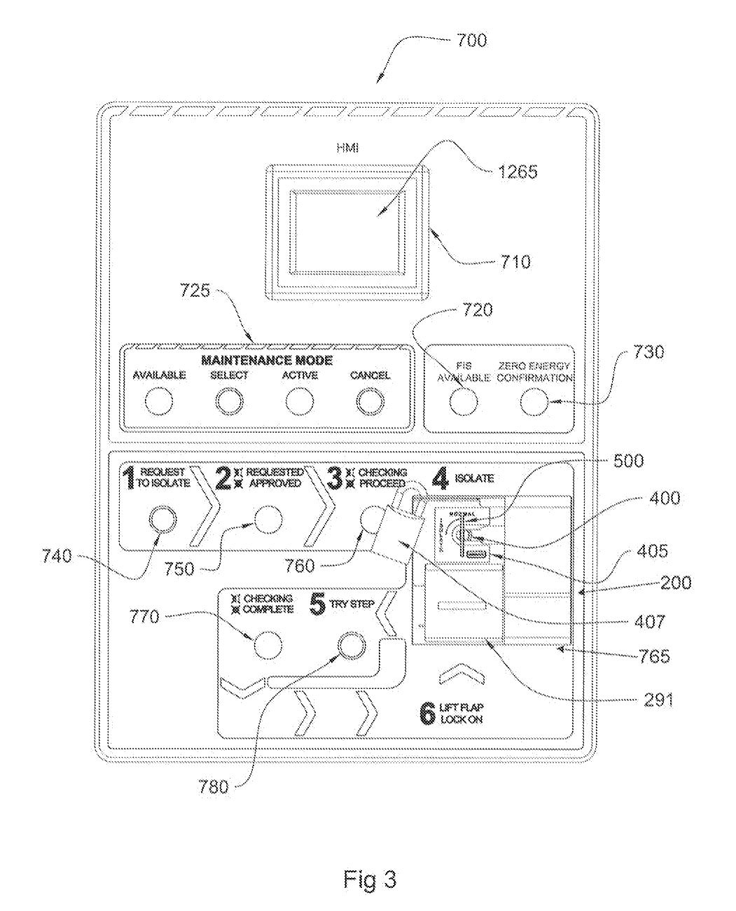

FIG. 3 shows a control panel provided inside the remote isolation station of FIG. 2 with the conveyor belt system in a normal state.

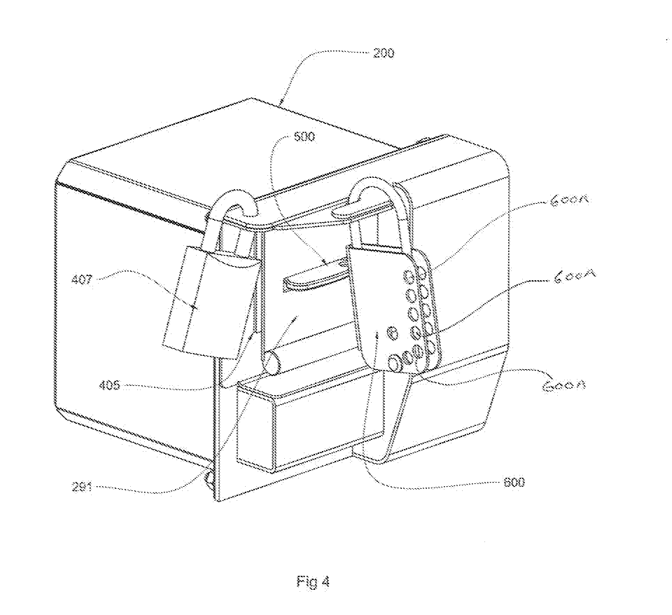

FIG. 4 shows an isolation lockout switch box used in the control panel of FIG. 3 and showing the isolation lockout switch in isolation lockout condition.

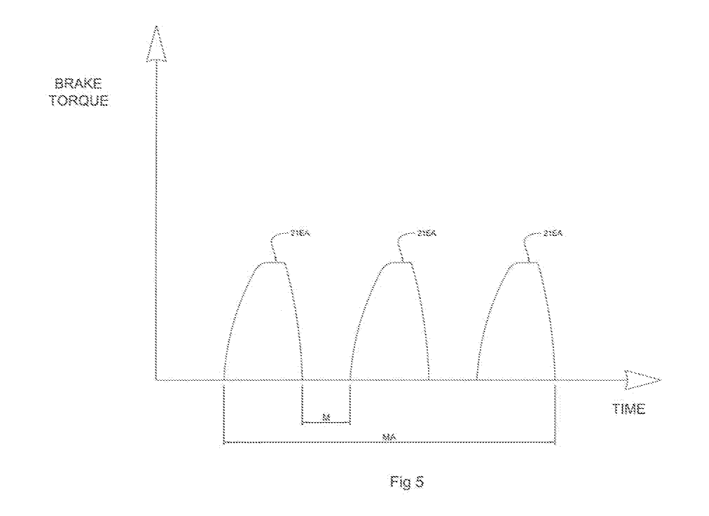

FIG. 5 provides a plot showing braking action for the conveyor belt system of FIG. 1 prior to isolation by the equipment isolation system shown in FIG. 1.

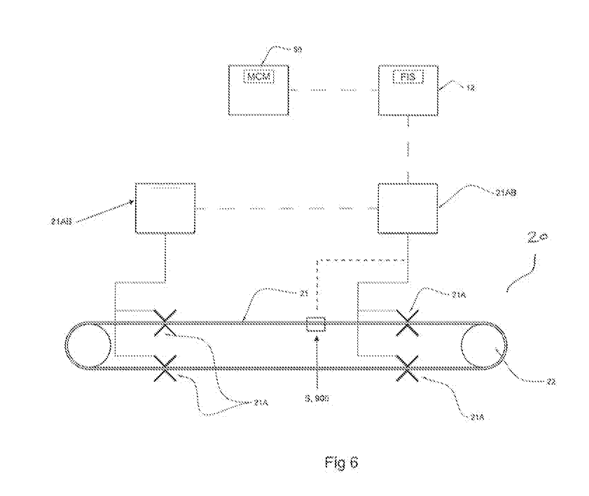

FIG. 6 shows a block diagram showing integration of mechanical security means, in the form of conveyor belt clamps, with a remote isolation station as shown in FIG. 2, for the conveyor belt system of FIG. 1.

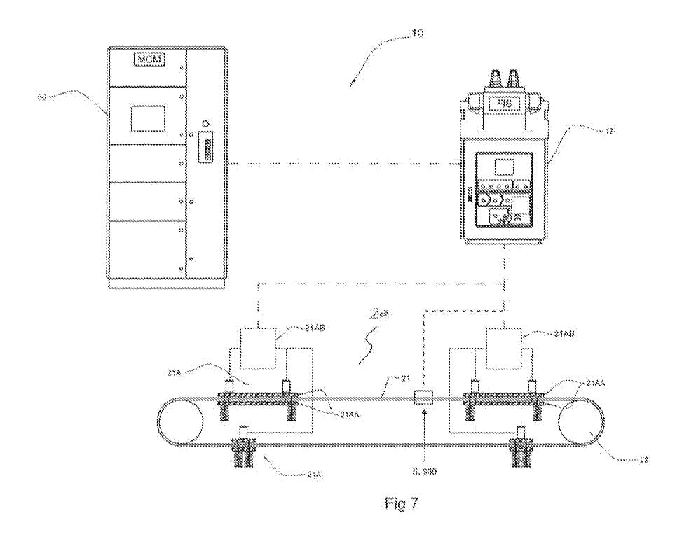

FIG. 7 shows a schematic view of an automated conveyor belt clamp system for use in the equipment isolation system shown in FIGS. 1 and 5.

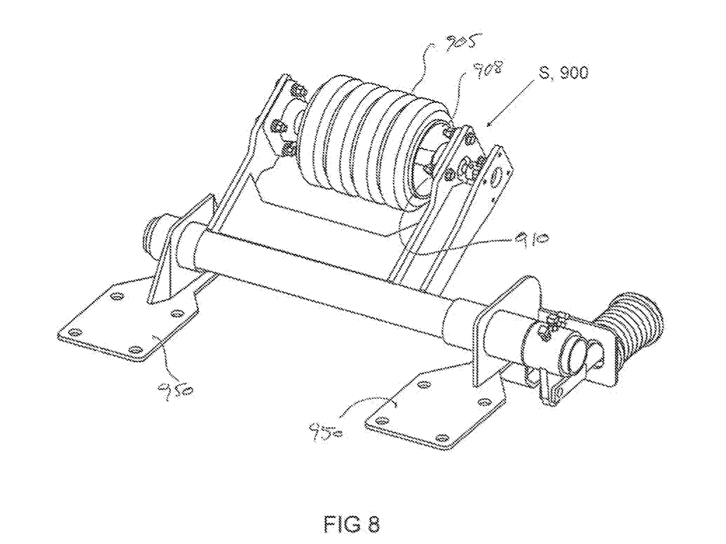

FIG. 8 shows a schematic view of a conveyor belt standstill monitor forming part of the conveyor belt system shown in FIGS. 1, 6 and 7.

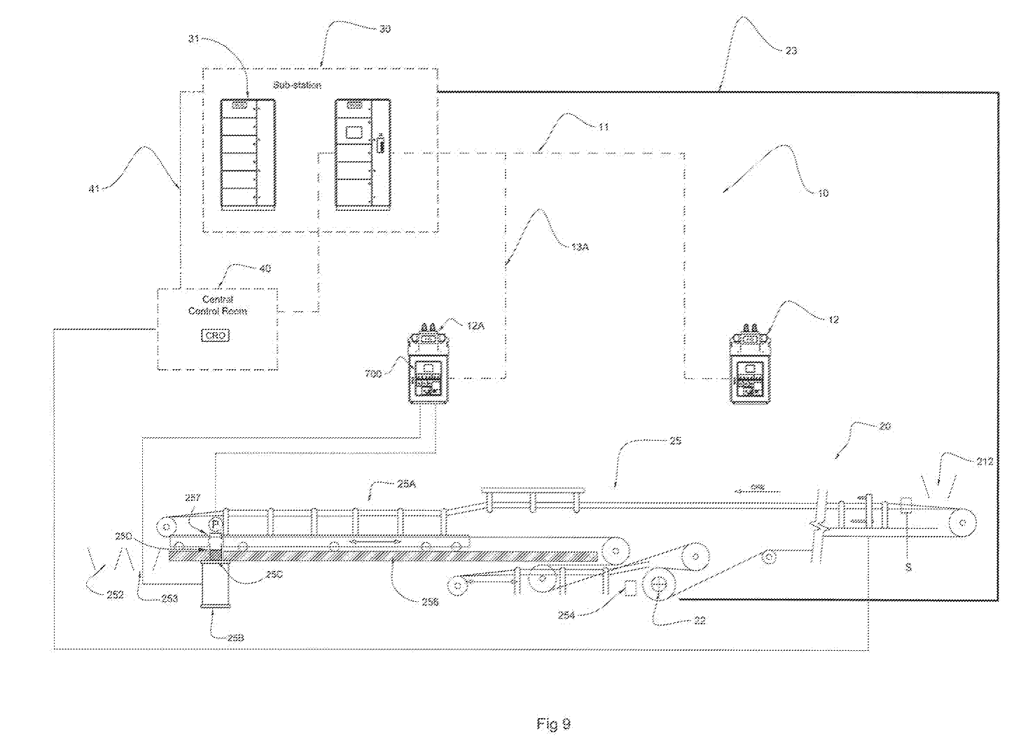

FIG. 9 shows a schematic view of a shuttle conveyor forming part of the conveyor belt system shown in FIG. 1 and including mechanical security means in the form of shuttle locking pins.

Referring to FIG. 1, there is shown a schematic layout of a remote equipment isolation system 10, as retrofitted to an existing conveyor belt system 20, for example a long range conveyor system for conveying iron ore from a mine site to a port for shipment. The conveyor belt system 20 comprises a troughed conveyor belt 21 feeding a shuttle conveyor system 25 described further below with reference to FIG. 9. Conveyor belt 21 has a head pulley motor 22 driven by an electrical supply emanating from electrical contacts 31, whether provided as contactors or circuit breakers. One contact is a standard contactor for “ON”/“OFF” operation of the motor 22. The head pulley motor 22 is powered through a Variable Speed Drive (VSD) which is electrically powered from a 3 phase AC power supply line 23 providing voltages of less than 1000V AC. The electrical power is supplied from a sub-station 30. The sub-station 30 houses the contacts 31. Activation of the contacts 31 (i.e. placing them in the “off” or “break” state), de-energises all 3 phases of the electrical supply to the conveyor head pulley drive motor 22. Conveyor speed is sensed by a belt movement monitor 900 as will be discussed later with reference to FIG. 8. Such de-energisation is continuously monitored by a voltage monitor relay (not shown) located downstream of contacts 31, i.e. on the conveyor belt system 20 side of the contacts 31.

The conveyor belt system 20 also includes a Tramp Metal Detector (TMD) 21B for detecting tramp metal which requires removal to avoid damage to the conveyor belt 21. Prior to removal of tramp metal, the conveyor belt system 20 requires isolation, as described below, to make removal safer.

The conveyor belt system 20 and sub-station 30 are under the control and supervision of a plant control system 260 having a CCR (Central Control Room) 40, via a DCS (Distributed Control System), PLC (Programmable Logic Controller) and SCADA (Supervisory Control and Data Acquisition System) as are commonly used and would be well understood by the skilled person. Item 41 in FIG. 1 is representative of a communication and control network between the CCR and the various other plant and isolation systems and components. A Control Room Operator (CRO) 42 is located within the CCR 40 and has various input/output (I/O) devices and displays available for the proper supervision and control of the conveyor belt system 20. Except for the remote isolation system 10, the above description represents a conventional system as would be known within the materials handling and mining industries.

The remote isolation system 10 comprises fixed remote isolation stations 12 and 14 which are located proximate to the conveyor belt system 20. As will be evident from FIGS. 3 and 4, remote isolation stations 12 and 14 include control panels 700 for use in operating the remote isolation system 10. Each control panel 700 is integrated with a dedicated isolation switch box 200 and isolation lockout switch 400 for completing isolation of conveyor belt system 20 as described below. It will be understood that remote isolation stations 12 and 14 could be replaced or supplemented by one or more mobile isolation stations, for example in the form of portable computer devices (in certain applications these potentially being provided as smartphones) or communication devices using wireless communications, as disclosed for example in the Applicant's Australian Provisional Patent Application Nos. 2015902561 and 2015902562, the contents of which are incorporated herein by way of reference. The remote isolation stations 12 and 14 may be powered from the plant grid, other power networks or alternative power sources, conveniently such as via solar power.

The remote isolation system 10 also includes a master controller 50 incorporating a Human/Machine Interface (HMI) in the form of a touch sensitive screen 51 which displays human interpretable information. The master controller 50 is also located within sub-station 30. Remote isolation stations 12 and 14 are in communication with the master controller 50 and each other via communication channels such as channels 11 and 13. These communication channels can be provided in any suitable form including hard wired or wireless forms that satisfy known industrial open communication protocols with Ethernet communications being particularly preferred to enable flexible system updating. Communications must be via safety rated communications protocol software, noting that these may be varied depending on the PLC platform used. For example, the Interbus Safety or PROFIsafe software solutions provide an indication of existing systems which are well known within the mining and materials handling industries. This will ensure that the communication channels are monitored and diagnostic tools are available for fault control and rectification when required.

Further description of the electrical layout and operation of the remote isolation system 10 is provided in the Applicants granted Australian Patent No. 2010310881, the contents of which are incorporated herein by way of reference.

In summary, the conveyor belt system 20 is isolated, following tripping of the Tramp Metal Detector (TMD) 21B by tramp metal, by a process involving:
An operator request at remote isolation station 12 or 14 for the control system to approve isolation of all or part of the conveyor belt system 20 including conveyor belt 21 and drive motor 22 in accordance with a preferred mode of isolation developed by the Applicant and described in Australian Provisional Patent Application No. 2015902558, the contents of which are incorporated herein by way of reference;
Isolation being approved if the operator request meets permissives for isolation, for example as described in the Applicant's Australian Patent No. 2010310881;
A try start process being invoked to check that the isolation is effective, which involves checking that electrical contacts for the conveyor belt system 20 are in an isolated position with no voltage being detected by the voltage monitor relay downstream of the electrical contacts 31 (and desirably, conveyor belt movement sensors such as movement speed sensor S and/or belt standstill monitor 900 confirming that the conveyor belt 21 has come to a complete stop as described below); an attempt to re-start the conveyor belt system 20 using try step button 780 or an automated process; and checking that there is no re-energisation of conveyor belt system 20 using the same sensors; and
Lockout at a control panel of remote isolation station 12 and/or 14, with the isolation lockout switch 400 of isolation switch box 200 as shown in FIG. 4, if the try start process is unsuccessful (as required) and stored energy tests show that, for all practical safety purposes, energy has been dissipated from the conveyor belt system 20 and the remote isolation system 10 can proceed to isolate.

Further description of the isolation as effected on the conveyor belt system refers only to remote isolation station 12 but is to be understood to be equally applicable to remote isolation station 14.

The isolation procedure requires dissipation of energy which could otherwise cause safety hazards from undesirable movement of the conveyor belt 21. The conveyor belt system 20 includes a brake 21E which is activated to bring the conveyor belt 21 to a stop. At least one stored energy test is then performed to ensure that conveyor belt 21 is stationary and that all stored energy has been released. The conveyor belt movement sensor S, 900 shown in further detail in FIG. 8 and which can sense motion or travel in forward and reverse directions for the conveyor belt 21, is used to ensure that the conveyor belt 21 has come to a complete stop before isolation is effected. The speed sensor S could be provided as, or in conjunction with, a belt standstill monitor as would be known in the industry. For example, plant control system 260 may command release of conveyor brake 21E and then the conveyor belt 21 may again be monitored for movement by speed sensor S. When the conveyor belt 21 is confirmed stationary with zero speed sensed by sensor S, the brake 21E will be re-applied. The brake 21E will then be released again with the conveyor belt 21 being again monitored for movement by sensor S. This procedure may be repeated as many times as necessary until sensor S and consequently the plant control system 260 confirms that the conveyor belt 21 is completely stationary with all stored energy released or dissipated. This process may be demonstrated with reference to FIG. 5 showing a plot of brake 21E action, as reflected by brake torque, against time. Here brake 21E is applied in three pulses 21EA, of approximately equal length, with belt movement monitor S, 900 continuously monitoring movement at all times including during time intervals M between brake pulses 21EA. When no movement is sensed by belt movement monitor S, 900 after three pulses 21EA (corresponding with a certain elapsed time MA), control system 260 sends a signal to control panel 700 that the operator may proceed to isolation switch lockout as described below.

On conclusion of the above isolation procedure, remote isolation system 10 continuously monitors the integrity of conveyor belt system 20 isolation by continuous monitoring of signals received from the plurality of sensors described herein. Threats to such isolation integrity typically imply safety hazards, such as may result from conveyor belt movement, that may be pre-empted and compensated for with the equipment isolation system. As a plurality of potential threats to isolation integrity may exist, securing isolation system integrity involves the use of a combination of monitoring and securing systems for addressing the most probable threats to isolation integrity for the conveyor belt system 20. As described below, these monitoring systems include:
A perimeter monitoring system including sensors 705 (as can be seen with reference to FIG. 2) for providing surveillance at a perimeter of remote isolation station 12 and alarms for providing alert signals where the perimeter is breached, or is at risk of breach, in an unauthorised manner, whatever the cause of that breach.
A monitoring system for detecting any movement of the isolation lockout switch 400 and its associated key 500 from an isolated position which could result in an undesirable or hazardous re-energisation of conveyor belt system 20.
A securing means involving mechanical devices, in the form of automated belt clamps integrated with remote isolation system 10 to prevent movement of the conveyor belt 21 whilst isolated.
A monitoring system for detecting stored energy in the conveyor belt system 20 during isolation, suitable stored energy tests including those described above and continuous conveyor belt speed monitoring using speed sensor S.
A securing means involving mechanical devices, in the form of shuttle locking pins integrated with remote isolation system 10 to prevent movement of the shuttle conveyor 25 whilst isolated.
A monitoring system for detecting slackening off of the conveyor belt 21 in certain arrangements after associated counter-weights (not shown) are lowered to eliminate tension from the belt 21 and thus ensure no potential energy remains prior to and during an isolation event being effected.
   The first monitoring system identifies threats of unauthorised entry to remote isolation station 12 and, in particular, its control panel 700 for which it forms an enclosure or box, i.e. (a perimeter). As shown in FIG. 2, remote isolation station 12 is mounted on post 12A and has an access door 122 enabling access to the control panel 700, this access door 122 normally being closed to unauthorised personnel to protect the control panel 700 and other safety critical components, including isolation lockout switch box 200 and lockout switch 400, from damage, typically from human interference or climatic factors. The access door 122 should not be opened, exposing these safety critical components, without authorisation. The access door 122 is therefore provided with one or more sensors 123, such as position, tamper or limit switches, to detect movement in position or status of the door 122 from a closed position, irrespective of the cause of a change in door position. The sensor 123 continuously monitors the position or status of the door 122, at least whilst conveyor belt 21 is in an isolated state. Where motion or a change of position is detected, the sensor or limit switch 123 triggers alert signals through alarms 124 and 126 fitted to the remote isolation station 12. Alarm 124 is a siren and alarm 126 is a light beacon which includes a light 126A which flashes red when triggered by the door limit switch 123. Siren 124 (which may include start up warning horns for conveyor belt system 20) may be pulsed in a preferred manner to represent the condition alarm. An alert signal is also sent to the controller 50 and central control room 40 so that corrective action can be initiated as required. Corrective action may involve tripping of a shunt trip device (not shown) at substation 30, fail-safe deactivation of the isolation system 10 and a reset of the remote isolation system 10 following an investigation to locate the cause and effects of the detected unauthorised access to remote isolation station 12. Ideally, all access doors to remote isolation stations 12, 14 are fitted with door limit switches 123 as described above.

The second monitoring system, which operates independently of the first, is described with reference to FIG. 3 showing a schematic of a control panel 700 located within the remote isolation station 12. Panel 700 has a Human Machine Interface (HMI) 710 with a touch screen 1265 (though less fragile buttons, switches and other input devices may be used in alternative arrangements) for entering commands including issuing isolation requests to the plant control system. A request button 740 is provided for isolation requests. Information can also be presented on screen 1265 in respect of any such isolation requests. Control panel 700 also includes:
indicator light 720 showing whether or not the remote isolation station 12 or 14 is available for isolation; as well as whether the conveyor belt system 20 is in the desired isolation mode (as described in the Applicant's Australian Provisional Patent Application No. 2015902558;
indicator light 725 showing whether or not exclusive or maintenance mode for the remote isolation system is active as described in Australian Provisional Patent Application No. 2015902557 (with the remote isolation station 12 exclusively controlling operation of the conveyor belt system 20), the contents of which are incorporated herein by way of reference; and respective “select” and “cancel” buttons for initiating or terminating the maintenance mode;
indicator light 730 to provide zero energy confirmation when sensors, such as at least the voltage monitor relay described above for contacts 31, and preferably conveyor belt 21 movement sensors as well, indicate zero hazardous energy in the conveyor belt system 20;
request isolation button 740 which is activated by an operator (and which illuminates when pressed) to request isolation and “request approved” indicator light 750 which illuminates to provide status information to said operator;
indicator light block 760 for showing correctness of selection of conveyor belt 21 for isolation and for indicating that control system checking is taking place subsequent to an isolation request being instigated;
indicator light block 770 for showing whether or not the isolation process is complete following control system checking;
try step button 780 for requesting a try start as described above;
isolation switch block 765 including switch box 200 with isolation lockout switch 400 (shown with key 500 in a normal position with keeper plate 405 locked by padlock 407 to prevent removal of key 500 from the isolation lockout switch 400). Isolation lockout is further evident with reference to FIG. 4 showing the isolation switch box 200 detached from control panel 700. Lockout switch 400 has key 500 in the isolated position with flap lock member 291 in correct position for application of hasp 600 securely and correctly accommodated for isolation lockout. Multiple operators may need to lock out and hasp 600 includes hasp lockout points 600A to enable this to occur; and
graphics (in the form of arrows and text) illustrating the sequence of steps to be followed in the required isolation procedure.

Further description of the construction and operation of the lockout switch box 200 and isolation switch 400 is provided in the Applicant's Australian Provisional Patent Application No. 2015902554, the contents of which are incorporated herein by way of reference.

It is critical to safety that the isolation lock out switch 400 remains in the correct locked out position during isolation of conveyor belt 21. To that end, a second monitoring system for securing integrity of remote isolation system 10 includes sensors, such as proximity sensors to continuously monitor the position of the isolation key 500 in isolation lockout switch 400 and to ensure that various components (e.g. key 500, keeper plate 405 and flap 291) are correctly positioned in “resting” or NORMAL (energised), or “locked out” condition. Corrective action may be initiated if deviation from the correct position is indicated. Sensors can also be used to indicate tampering with hasp 600 and to initiate corrective action if tampering is detected. Alert signals may also be generated using the siren 124 and alarm 126. The signal could be different from that provided for the first monitoring system warning personnel to evacuate the working area for conveyor belt 21 if there is a significant risk of conveyor belt re-energisation, or movement, should the isolation lockout switch 400 be moved out of the correct isolated position. Corrective action may involve a reset of the remote isolation system 10 following an investigation to locate the cause and effects of deviation of the isolation lockout switch 400 from the correct lockout position.

A third monitoring system, though more aptly described a security system operating independently of the first monitoring system, provides additional security to those working on conveyor belt system 20 and conveyor belt 21, in particular, when isolated using the remote isolation system 10 as described in Australian Patent No. 2010310881 and above. This third monitoring system is described with reference to FIGS. 6 and 7. Conveyor belt 21 is provided with a number of automated belt clamps 21A for preventing belt movement during isolation. The number of belt clamps provided is typically dependent on the required holding torque required and possible mounting locations available for such clamps.

As shown in greater detail in FIG. 7, belt clamps 21A are arranged on the feed and return sides of the conveyor belt 21. Each belt clamp 21A comprises clamping plates 21AA that are brought into compressive engagement with conveyor belt 21 by a drive system 21AB including an electric motor under the control of master controller 50 of remote isolation system 10. When engaged the conveyor belt 21 should remain stationary with all energy dissipated.

Use of automated, rather than manually installed, belt clamps 21A saves time on conveyor belt maintenance and especially maintenance on the conveyor belt brake system 21E. Still further, time savings may also be achieved by integrating the engagement of belt clamps 21A with operation of the remote isolation system 10 as above described. The belt clamps 21A clamp the conveyor belt 21 by force and their engaged position may also be continuously monitored by the isolation control system. Accordingly, when isolation is approved, plant control system 260 instructs engagement of the belt clamps 21A with the conveyor belt 21 through drive system 21AB and confirms such engagement as part of the isolation procedure. Release of the belt clamps 21A by drive system 21AB is also controlled by plant control system 260. In this way, the belt clamps 21A do not require manual, or even automatic installation, in separate steps after isolation lockout has occurred which saves significant time for production. Further description of the automated belt clamp system is provided in the Applicant's Australian Provisional Patent Application No. 2015902565, the contents of which are incorporated herein by way of reference.

Use of conveyor belt clamps 21A should prevent movement of the conveyor belt 21, but conveyor belt speed or movement monitoring is also continuously conducted during isolation using speed sensor S, 900 to provide further safety assurance by checking that there is no conveyor belt 21 movement. Speed sensor S, which can also or alternatively be provided as a belt standstill monitor (BSM) 900, is shown in FIG. 8, and arranged to operate with the conveyor belt system 20. BSM 900 is ideally mounted, using mounting brackets 950, close to a belt support roller to prevent sagging of the conveyor belt 21 onto the unit. BSM 900 has a rotatable encoder roller 905 which is in contact with conveyor belt 21 and caused to rotate (either clockwise or anti-clockwise) by the movement of the belt 21. As it does so, a sensor arrangement 910, such as a Hall effect sensor, co-operates with a sensible index 908 on the encoder roller 905 allowing measurement of the rotational speed (which has a relationship with conveyor belt speed) in the manner of a conventional encoder.

The BSM 900 serves a number of key roles as are described below. Firstly, the BSM 900 is used to qualify one of the primary steps in the remote isolation process, that is, it confirms that the conveyor belt 21 is stationary. This enables a request to isolate by an operator (i.e. effected by pressing the “REQUEST TO ISOLATE” button 740 on the control panel 700) being recognised by the control system when received. Secondly, the BSM 900 is integral to the energy release or energy dissipation sub-routine as described hereinbefore where the conveyor brake 21E is applied and released to find the neutralised (and hence de-energised) position of the conveyor belt 21 prior to isolation. The BSM 900 facilitates continued execution cycles of the brake release routine until no movement is detected in the conveyor belt 21. Thirdly, the BSM 900 is used to continually monitor the conveyor belt 21 for movement when a remote isolation is in place and will activate alarms if movement is detected. Importantly, the BSM 900 is configured to be fit for the application purpose of a functional safety system and is designed to withstand the rigours of the installation, which involves actual contact with the conveyor belt 21 to provide direct sensing thereof.

As described above, the conveyor belt system 20 also includes a shuttle conveyor system 25 now described in more detail with reference to FIG. 9. In shuttle conveyor system 25, supported by structural members 256 and fed with iron ore from conveyor belt 21 through chute 212, a shuttle 25A at the head end of conveyor 25 moves an end or delivery tip of the conveyor back and forth, shuttling it into position over chutes 252 and 253 of a downstream conveyor (not shown). Such a shuttle conveyor may be isolated in essentially the same manner as described above and in Australian Patent No. 2010310881 using an additional remote isolation station 12A rather than less conveniently located remote isolation stations 12 and 14.

When isolated, a brake 254 for shuttle conveyor 25 is engaged and excessive reliance could be placed on that brake to hold the shuttle 25A in correct position for isolation over chute 252. This might be acceptable for minor tasks not requiring work on the shuttle 25A itself. However, as with conveyor belt clamps 21A described above, the shuttle conveyor 25 can be locked into isolation position so that shuttle 25A does not move using automated locking pins 25C driven within complementary recesses 257. The locking pins 25C are moved into position when required by electrically driven hydraulic ram 25B operated by plant control system 260 during operation of remote isolation system 10. Hydraulic ram 25B similarly retracts locking pins 25C from the locked position when shuttle conveyor 25 is ready for return to service following maintenance.

Use of automated, rather than manually installed, shuttle locking pins 25C saves time on shuttle maintenance. Still further, considerable time savings can be achieved by integrating the engagement of locking pins 25C with the remote isolation system 10 as above described. Accordingly, when isolation is approved, controller 50 instructs engagement of the locking pins 25C with the recesses 257 of shuttle conveyor 25 by hydraulic ram 25B and confirms such engagement as part of the isolation procedure. The shuttle locking pins 25C do not require manual, or even automatic, installation in separate steps after isolation lockout and this saves time for production. Further description of the shuttle locking pin system is provided in the Applicants Australian Provisional Patent Application No. 2015902566, the contents of which are incorporated herein by way of reference.

The equipment isolation system as described above provides a number of benefits. First, careful steps are taken to dissipate energy (in whatever form may cause hazard) before isolation of the conveyor belt system 20 can be effected. In this way, any potential safety hazards posed by the stored energy can be mitigated before any maintenance or other work is commenced on the isolated equipment. Second, isolation integrity during an isolation event provides even greater safety assurance by mitigating against risks of re-energisation of the conveyor belt system 20 and/or any misuse/tampering with the equipment isolation system 10. This continuous monitoring ensures the integrity of an isolation event is not compromised, as this may put anyone working on the equipment in danger of serious harm. Careful control over, and integration of, these aspects also helps minimise downtime and increases production for the overall plant or site.

In actual use, the equipment isolation system as described above typically involves transference of an equipment item from a de-isolated (or energised) state to an isolated state and then back to a de-isolated (or energised state). This is because the equipment isolation system is typically used to take the equipment item out of operation (an isolation event), in a safe and controlled manner, to enable maintenance or other work to be performed, before it is then returned back to normal operation.

Modifications and variations to the equipment isolation system of the present invention will be apparent to the skilled reader of this specification. Such modifications and variations are deemed within the scope of the present invention. For example, whilst the equipment isolation system has primarily been discussed with reference to a conveyor belt system and the dissipation of electrical and potential energy in such a system, the isolation system may have application to other types of equipment where continuous monitoring of different forms of energy, as alluded to hereinbefore, may be required.

Furthermore, while the control panel 700 has primarily been described as including a Human Machine Interface (HMI) 710 with a touch screen 1265 and a series of buttons and lights (e.g. 740, 750, 760, 770, 780 etc) to enable an operator to request an isolation event, it should be noted that the control panel 700, and specifically the touch screen 1265, may be configured to provide greater control and more information about isolation system steps to an operator (or indeed full control and all information to do with the isolation system). That is, a more ‘digitally’ based input means (or indeed a totally digital system) may be arranged for operation instead of an analogue or part analogue system as described herein to enable control of the equipment isolation system according to the present invention.

1. An equipment isolation system comprising:
at least one equipment item energisable by an energy source; and
a control system for automatically isolating said at least one equipment item from said energy source to an isolated state,
wherein said equipment isolation system includes means for securing the integrity of operation of said equipment isolation system, said securing means including at least one monitoring means for continuously monitoring the isolation state of said at least one equipment item through detection of undesired energy flow or possible energy flow therein.

2. An equipment isolation system as claimed in claim 1 wherein said monitoring means operates prior to an isolation being effected to ensure that all energy which could potentially cause a safety hazard is dissipated from the equipment item.

3. An equipment isolation system as claimed in claim 1 wherein each said monitoring means operates during an isolation to ensure the integrity of the isolation is not compromised once it has been instigated.

4. An equipment isolation system as claimed in claim 1 wherein a plurality of monitoring means are selected, preferably following a hazards analysis, to address at least any substantial threats to the integrity of the isolation system.

5. An equipment isolation system as claimed in claim 1 wherein at least one monitoring means operates independently of another.

6. An equipment isolation system as claimed in claim 1 wherein said securing means forms part of the control system, said securing means preferably including one or more electronic, mechanical or electro-mechanical device(s) for monitoring important components of the equipment isolation system.

7. An equipment isolation system as claimed in claim 6 wherein said monitoring device(s) provide a signal to the control system representative of a hazard to the integrity of the equipment isolation system.

8. An equipment isolation system as claimed in claim 7 wherein sensors are used to monitor the equipment isolation system providing signals indicating tampering, failure of, or other threats to, the integrity of the equipment isolation system.

9. An equipment isolation system as claimed in claim 1 wherein the securing means forms part of the equipment item being isolated and is operated as part of the isolation process.

10. An equipment isolation system as claimed in claim 1 wherein each said monitoring means includes a sensor, preferably a plurality of sensors, for detecting and/or monitoring undesired energy flow or possible energy flow in the equipment item.

11. An equipment isolation system as claimed in claim 10 wherein a sensor is selected from the group consisting of movement sensors, speed sensors, proximity sensors, voltage sensors, current sensors, temperature sensors, flow sensors and pressure sensors.

12. An equipment isolation system as claimed in claim 1 wherein said equipment item includes a conveyor belt system and said equipment isolation system implements steps to dissipate energy from the isolated, or to be isolated, conveyor belt system through stored energy tests prior to isolation.

13. An equipment isolation system as claimed in claim 1 wherein said equipment item is a conveyor belt system and said control system continuously monitors conveyor belt movement.

14. An equipment isolation system as claimed in claim 12 wherein said conveyor belt system includes a braking system with brake(s) for slowing and stopping conveyor belt movement, said brake(s) being released and applied in a braking cycle procedure during which the conveyor belt is continuously monitored for movement through stored energy testing employing at least one sensor, and preferably a plurality of sensors, until the control system confirms that hazardous stored energy has been released or dissipated, preferably by confirming that the conveyor belt is completely stationary.

15. An equipment isolation system as claimed in claim 12 wherein said at least one sensor, and preferably a plurality of sensors, is selected from the group consisting of belt speed sensors, belt standstill monitors, belt slack monitors, belt clamp position sensors, braking system temperature sensors and braking system pressure sensors including brake fluid pressure sensors and brake fluid temperature sensors.

16. An equipment isolation system as claimed in claim 1 enabling purposeful continuation of energy supply to selected equipment items where authorised by the control system.

17. An equipment isolation system as claimed in claim 16 wherein said equipment item is a conveyor belt system and an energy supply is maintained to the conveyor braking system to ensure that braking action is applied as required during an isolation or energy dissipation process.

18. An equipment isolation system as claimed in claim 1 wherein said control system approves isolation on permissible request logged by an operator at a remote isolation station.

19. An equipment isolation system as claimed in claim 1 comprising at least one isolation switch movable between a first position in which an equipment item is energised by an energy source and a second isolated position in which the equipment item is isolated from the energy source, and a locking device co-operates with the switch for locking it into said isolated position in a lockout process wherein the position of the locking device is monitored by sensors and the control system for correct positioning whether for isolated and de-isolated states when using the equipment isolation system.

20. An equipment isolation system as claimed in claim 19 wherein sensors, such as proximity sensors, are provided to monitor for tampering with a locked out isolation switch.

21. An equipment isolation system as claimed in claim 1 including at least one remote isolation station including a control panel to implement and monitor isolation procedures, the control panel being protected by an enclosure with a lockable door enabling access to important components of the isolation system wherein the enclosure is provided with perimeter security monitoring means that detect unauthorised attempts to access or tamper with the enclosure by force.

22. An equipment isolation system as claimed in claim 9 wherein said at least one equipment item includes a conveyor belt system and said securing means includes at least one of belt clamps and shuttle locking pins, engagement of said securing means being instructed and confirmed by the control system.

23. An equipment isolation system as claimed in claim 1 wherein the equipment item is transferred from a de-isolated (energised) state, to an isolated state where it is isolated from said energy source and continuous monitoring of the isolated state occurs, and back to a de-isolated (energised) state.
